(19) United States
(12) Patent Application Publication
(10) Pub. No.: US 2017/0238543 A1
(43) Pub. Date: Aug. 24, 2017

(54) AN ALDEHYDE CONTAINING COMPOSITION FOR INSECT CONTROL

(71) Applicant: MICROBIDE LIMITED, Dublin (IE)

(72) Inventor: Mary SKELLY, Dublin (IE)

(73) Assignee: MICROBIDE LIMITED, Dublin (IE)

(21) Appl. No.: 15/516,725

(22) PCT Filed: Oct. 2, 2015
(86) PCT No.: PCT/IB2015/001651

§ 371 Date: Apr. 4, 2017

(30) Foreign Application Priority Data
Sep. 17, 2014 (ZA) 2014/06844

(51) Int. Cl. A01N 35/02; A01N 49/00; A01N 43/08; A01N 25/14; A01N 25/04

(52) U.S. Cl. CPC A01N 35/02; A01N 25/14; A01N 25/04; A01N 43/08; A01N 49/00

(57) ABSTRACT

This invention relates generally to use of a stable aqueous carbonyl compound containing solution, or a mixture of different carbonyl compounds containing solutions, in a program of integrated vector management.

### BACKGROUND OF THE INVENTION

The invention relates to use of carbonyl composition for the control of insect vectors and to a method of control of insect vectors using the composition.

Insects are arthropods, characterized in at least the adult having a chitinous exoskeleton.

Certain insects, for example termites, mosquitoes, ants, lice, fleas or cockroaches are familial pests or vectors of disease. Notable among these are mosquitoes that are well known to be vectors of infectious viral and protozoal diseases such as, for example, Malaria, Yellow Fever, Dengue Fever and West Nile Virus. Mosquitoes are not the only vectors however. Another example is the black fly as a vector of River Blindness. A further and topical example are bed bugs and their demonstrated potential to carry and transmit MRSA and VRE.

To illustrate the extend of the problem of disease and vector control in the U.S., structural pest control industry generated an estimated $7.213 billion in total service revenue in 2013, a 6% increase from 2012. Pest control services were directed, most commonly, to termites, bed bugs and cockroaches.

With respect to bedbugs, in the US, 86.5% of business respondents to a survey said their company treated for bed bugs. Six of ten respondents primarily relied on insecticide treatments to control bed bugs. One in five respondents relied on heat or steam treatments.

People in single family homes and apartments were the leading users of pest control services for bed bugs treatment, followed by hotels and motels.

Termite and flying ant swarms vary from year to year depending on climate conditions. Nevertheless, both pre- and post-construction termite treatment is a growing business in the US, with nearly half of all privately owned housing developments in the U.S. receives a pre-construction termite treatment this past year.

While there are a number of management techniques to address the resultant human and animal diseases facilitated by insects, such as vaccination and therapeutics, it is apparent that disease resistance to some of these therapies has become a significant problem.

Vaccination is problematic in terms of availability, affordability and the potential for other untoward long-term effects in humans and food-stock animals.

Certain insecticides have been overused which, in some cases, has made these pesticides less effective due to resistance with resistant insects posing ever increasing challenge.

Low technology solutions can also be used. These solutions include simply turning over trapped water in a container and, on a larger more environmentally damaging scale, to large-scale draining of marsh water levels.

Lavicides, as a class of insecticide, interrupt the lifecycle of a particular insect at an immature stage of the cycle the larvae can mature into an adult and disperse to broader territory.

Larviciding can reduce overall pesticide usage in a control program. Killing, for example, mosquito larvae before they emerge as adults, can reduce or eliminate the need for ground or aerial application of pesticides to kill adult, for example, mosquitoes.

A combination of chemical measures (use of lavicides) and biological measures may be employed to kill insects at the larval stages, but many of these measures are potentially harmful to the environment. Therefore, there is an on-going need for environmentally safe yet effective larvicides.

The ideal larvidicide would have the following properties: effectiveness at low doses, rapid kill, effectiveness against all immature insect stages, species specificity, lack of effect on non-target species, environmentally friendly, low mammalian toxicity, no cross resistance to existing active ingredients, ease of formulation, long shelf-life, potential for residual activity yet no bioaccumulation, the ability to self-spread, and uniformity within a water column.

Some examples of larvicides include:

(a) broad-spectrum insecticides—the organo-phosphates temephos, chlorpyrifos, fenthion, pirimiphos-methyl, and the tetracyclic macrolide neurotoxin spinosad;
(b) bacterial larvicides—Bacillus thuringiensis var israelensis), and Bacillus sphaericus;
(c) insect growth regulators—s-methoprene, pyriproxyfen, diflubenzuron, and novaluron; and
(d) monomolecular surface films—isostearyl alcohols, mineral oils.

Among the organophosphate pesticides, temephos (known under the trademark Abate) was registered by US EPA in 1965 to control mosquito larvae, and it is the only organophosphate with larvicidal use. Temephos is an important resistance management tool for mosquito control programs by preventing mosquitoes from developing resistance to the bacterial larvicides.

Temephos is used in areas of standing water, shallow ponds, swamps, marshes, and intertidal zones and may be used along with other mosquito control measures in an integrated vector control (IVC) program. Temephos is applied most commonly by helicopter but can be applied by backpack sprayers, fixed-wing aircraft, and right-of-way sprayers in either liquid or granular form.

Temephos, applied according to label instructions for mosquito control, has no unreasonable risk to human health. It is applied to water, and the amount of temephos used in relation to the area covered is very small. Temephos breaks down within a few days in water, and post-application exposure is minimal. However, at high dosages, temephos, like other organophosphates, can over-stimulate the nervous system causing nausea, dizziness, and confusion.

Because temephos is applied directly to water, it is not expected to have a direct impact on terrestrial animals or birds. However application of temphos does pose some risk to non-target aquatic species and the aquatic ecosystem. Although temephos presents relatively low risk to birds and terrestrial species, available information suggests that it is more toxic to aquatic invertebrates than alternative larvicides. For this reason, its use is limited to areas where less-hazardous alternatives would not be effective. In this case risk mitigation includes limiting the use of high application rates by specifying intervals between applications.

Spinosad is a newer biological insecticide. Spinosa is a mixture of two types of tetracyclic macrolide neurotoxin spinosyn. Spinasyn is produced during the fermentation of the soil actinomycete Saccharopolyspora spinosa. Spinosad effective against insect larva, and does not exhibit cross-resistance with existing insecticides. Spinosad has been shown to have a more favourable toxicological profile than temephos.

Natural larvicides, such as predatory fish, or bacterial insecticides such as bacillus thuringiensis israelensis and bacillus sphaericus, can be used as an effective solution for mosquito control. However their use is not always practical or suited to the habitat used by insects for the immature stages of their lifecycle. And, in the case of microbial larvicides, which have no residual efficacy, the costs of weekly applications should be considered in relation to the reduction in disease transmission intensity. The efficacy of bacterial larvicides is also dependent on both water temperature and larvae densities.

Bacillus thuringiensis israelensis is a naturally occurring soil bacteria that produces four types of toxic spores. The spores are eaten by mosquito larvae, but not by pupae or emerging insects. This solution is highly specific, and has a low order of toxicity.

Bacillus sphaericus is also a naturally occurring soil bacteria that is effective against Culex mosquitoes and some Annopheles and Aedes species. Bacillus sphaericus is beneficial in situations where there is high organic pollution.

Methoprene is a compound first registered by EPA in 1975 which mimics the action of an insect growth-regulating hormone and prevents the normal maturation of insect larvae. Methoprene is applied to water to kill mosquito larvae. It can be used along with other mosquito control measures in an IVC program. The methoprene product used in mosquito control is known as Altosid, and it is applied as briquettes, pellets, sand granules, and liquids. The liquid and pelletized formulations can be applied by helicopter and fixed-wing aircraft.

Methoprene used in mosquito control programs does not pose unreasonable risks to wildlife or the environment. When used for mosquito control according to its label directions, does not pose unreasonable risks to human health. Toxicity of methoprene to birds and fish is low, and it is nontoxic to bees. Methoprene breaks down quickly in water and soil and will not leach into ground water. Methoprene mosquito control products present minimal acute and chronic risk to freshwater fish, freshwater invertebrates, and estuarine species.

Oils are used as a pesticide by forming a coating on top of water to drown larvae, pupae, and emerging adult mosquitoes. These oils are specially derived from petroleum distillates and have been used for many years in the United States to kill aphids on crops and orchard trees, and to control mosquitoes. They may be used along with other mosquito control measures in an IVC program. Examples of oils used in mosquito control are (as knowing by trade names) Bonide, BVA2, and Golden Bear-1111, (GB-1111).

Oils, used according to label directions for larva and pupa control, do not pose a risk to human health. In addition to low toxicity, there is little opportunity for human exposure, since the material is applied directly to ditches, ponds, marshes, or flooded areas that are not drinking water sources. However, oils, if misapplied, may be toxic to fish and other aquatic organisms. For that reason, the US EPA has established specific precautions on the label to reduce such risks.

Monomolecular films are low-toxicity pesticides that spread a thin film on the surface of the water that makes it difficult for mosquito larvae, pupae, and emerging adults to attach to the water's surface. These chemicals cause a ‘wetting’ effect on the tracheal structures of the insect and ultimately the failure of the mosquitoes natural respiratory system causing them to drown. Films may remain active typically for 10-14 days on standing water, and have been used in the United States in floodwaters, brackish waters, and ponds. The effect is not immediate. They may be used along with other mosquito control measures in IVC program. Examples of these films, as known by the trade names, are Arosurf MSF and Agnique MMF.

Monomolecular films, used according to label directions for larva and pupa control, do not pose a risk to human health. In addition to low toxicity, there is little opportunity for human exposure, since the material is applied directly to ditches, ponds, marshes, or flooded areas that are not drinking water sources for humans.

Monomolecular films, used according to label directions for larva and pupa control, pose minimal risks to the environment. They do not last very long in the environment, and are usually applied only to standing water, such as roadside ditches, woodland pools, or containers which contain few non-target organisms.

The disadvantage with the use of oils and films is that they affect other life forms in the water body, and they are generally not biodegradable.

It is an objective of the invention at least to partially address the aforementioned problems.

### SUMMARY OF INVENTION

This invention relates generally to use of a stable aqueous carbonyl compound containing solution, or a mixture of different carbonyl compounds containing solutions, in a program of integrated vector management.

Hereinafter, “a carbonyl compound” refers to an organic compound containing at least one carbonyl functional group.

Hereinafter, “stable”, in the context of the invention, refers to an aqueous solution capable of being stored for a period of at least 12 months without the pH dropping below 5 or the molecules polymerizing thereby causing the product to become biocidally ineffective.

Hereinafter, reference to the term “an immature form of an insect” means at least one of the following insect lifecycle stages: egg, larvae, nymph and pupae.

Hereinafter, reference to “insect control” or “controlling insects” refers to the ability to maintain insect populations to a level that will reduce or prevent that insect population from being a nuisance or transmitting a particular disease.

Hereinafter, reference to “complex” refers to a process whereby the relevant reactants chemically interact or bond and the interaction includes micellization, i.e. the creation of micelles.

Compounds, chemical moieties or groups described in conjunction with a particular aspect, embodiment or example of the invention are to be understood to be applicable to any other aspect, embodiment or example described herein unless incompatible therewith.

The invention provides, in a first aspect, a method of insect control by reducing the surface tension of a body of water containing the egg stage of the insect, the method including the step of applying a stable aqueous carbonyl compound containing solution to the surface of the body of water, wherein the solution includes:
a) at least one carbonyl compound;
b) a surfactant or detergent;
c) a pH modifier; and
d) a buffer.

The solution may be prepared, prior to application, by:
(a) adding the surfactant to a volume of water, heated to between 30° C. and 70° C.;
(b) adding the pH modifier to adjust the pH of the solution to within 6.0 to 8.5
(c) adding at least one carbonyl compound to the body of water, to allow the carbonyl compound and the surfactant to complex, whilst maintaining the temperature within the range 30° C. and 70° C., for at least 10 minutes;
(d) reducing the temperature of the body of water to below 30° C. to slow further complexation of the carbonyl compound with the surfactant; and
(e) adding the buffer to the solution to buffer the pH and to produce the stable aqueous carbonyl compound containing solution.

The carbonyl compound may be at least one of the following: an aldehyde, a ketone, a terpenoid and a lactone.

The invention provides, in a second aspect, a method of insect control comprising the step of applying, to an environment containing an immature form of the insect, a stable aqueous carbonyl compound containing solution, the solution including:
a) at least one carbonyl compound.
b) a surfactant or detergent;
c) a pH modifier; and
d) a buffer.

The carbonyl compound may be at least one of the following: an aldehyde, a ketone, a terpenoid and a lactone.

The solution may be applied to the environment by spraying a dispersant

The dispersant may be a diluted form of the stable aqueous carbonyl solution, diluted either with distilled or potable water, an alcohol or a solvent. dispersant may have greater biocidal efficacy at lower temperatures than the stable aqueous carbonyl solution in an undiluted state

Alternatively, or additionally, the solution or the dispersant may be administered in the form of a spray, a fog, a foam or mist.

If the environment is a body of water, the solution may be applied as fast dissolving or disintegrating granules or pellets. The granules may be, for example, compressed peat granules or pellet.

The method includes the step of producing a foam of the solution, prior to application.

The invention provides in a third aspect, an insecticidal composition which includes:
a) at least one carbonyl compound;
b) a surfactant or detergent;
c) a pH modifier; and
d) a buffer.

The carbonyl compound may be at least one of the following: an aldehyde, a ketone, a terpenoid and a lactone.

The invention provides, in a fourth aspect, use of a stable aqueous aldehyde solution for the control of insects, the solution including:
a) at least one carbonyl compound
b) a surfactant or detergent;
c) a pH modifier; and
d) a buffer.

The carbonyl compound may be at least one of the following: an aldehyde, a ketone, a terpenoid and a lactone.

In respect of each aspect of the invention, the following may be present in the solution in the following concentration ranges:
a) the carbonyl compound—0.001% to 45% m/v;
b) the surfactant or detergent—0.1% to 45% m/v; and
c) the buffer—0.05% to 25% m/v.

The surfactant or detergent may be chosen from one or more of the following: an alcohol ethoxylate surfactant, a nonylphenol surfactant, an alkyl glycoside, sulphonic acid, sodium lauryl ethyl sulphate, sodium lauryl sulphate, a twin chain quaternary ammonium compound, cocopropyldiamide (CPAD), alkyl sulphate esters, benzenesulfonic acid, C10-13-alkyl derivatives and their sodium salts, D-glucopyranose, oligomeric glycosides and sorbitan monostearate.

Preferably, the surfactant or detergent may be one or more of the following: an alcohol ethoxylate surfactant, either linear or branched; a glucose-based carbohydrate derivative, for example a alkylpolyglucoside, a glucamide or a glucamine oxide; a surfactant blend of alternative nonionics or a blend that includes anionic or amphoteric surfactants such as, for example, sodium lauryl sulphate, or a sorbitan ester, ethanol and propanol.

The alcohol ethoxylate surfactant may include 3 to 12 ethoxylate groups depending on the composition of the stable aqueous carbonyl solution and the foaming properties required for a specific application of the stable aqueous carbonyl solution.

In respect of each aspect of the invention, the buffer may include at least one of the following: calcium acetate, magnesium acetate, sodium acetate, sodium acetate tri-hydrate, potassium acetate, lithium acetate, propylene glycol, hexalene glycol, sodium phosphate, sodium tri-phosphate, potassium phosphate, lithium phosphate, zinc perchlorate, zinc sulphate, cupric chlorate and cupric sulphate.

Preferably, the buffer may be a buffer mixture which includes at least sodium acetate trihydrate and potassium acetate.

Sodium acetate trihydrate and potassium acetate may each have a concentration in the buffer mixture of between 0.250 and 1.5 grams/litre.

In respect of each aspect of the invention, wherein, when the at least one carbonyl compound is an aldehyde, the aldehyde may be one or more of the following: formaldehyde, acetaldehyde, glyceraldehyde, proprionaldehyde, butraldehyde, pentanaldehyde, methyl pentanaldehyde, ethyl pentanaldehyde, tiglic aldehyde, valeraldehyde, iso-valeraldehyde, hexanaldehyde, heptanaldehyde, octanaldehyde, nonanaldehyde, 2-ethyl hexaldehyde, decanaldehyde, undecanaldehyde, dodecyl aldehyde, cuminaldehyde, benzaldehyde, iso-valeraldehyde, chloraldehyde hydrate, furfuraldehyde, paraformaldehyde, ethane dialdehyde, glyoxal, succinaldehyde, glutaraldehyde, adipaldehyde, iso-phthalaldehyde, ortho-phthalaldehyde, cinnamaldehyde, salicylaldehyde and malonaldehyde.

The terpenoid may be citral and ketone may be acetone.

The solution may include more than one type of carbonyl compound. The solution may include a mixture of aldehyde, ketone, terpenoid and lactones.

Alternatively, the solution may include a mixture of one or more aldehydes, for example: glutaraldehyde and ethane dialdehyde; ethane dialdehyde and chloradehyde trihydrate; acetaldehyde and ethane dialdehyde; paraformaldehyde and glutaraldehyde; glutaraldehyde and succinaldehyde; glutaraldehyde and adipaldehyde and ethane dialdehyde and succinaldehyde.

In respect of each aspect of the invention, the pH modifier may be any one or more of the following: potassium hydroxide, sodium hydroxide, sodium phosphate and sodium bicarbonate.

Preferably, the pH modifier is potassium hydroxide in a one molar solution.

A twin chain quaternary ammonium compound, with sterically hindered ammonium groups, may be added to the stable aqueous aldehyde solution for its fungicidal and foaming properties.

In respect of each aspect of the invention, the solution may include an insect attractant, such as acetone.

In respect of each aspect of the invention, the solution may include an adjuvant, which aids in the application, or improves the effectiveness, of the solution. The adjuvant may be a wetting agent, a dispersant or spreading agent, an emulsifier, a dispensing agent, a foaming adjuvant, a foam suppressant, a penetrant, a thickener, an anti-freeze agent, a disinfectant and a carrier.

The adjuvant may be a complementary or symbiotic insecticide such as, for example, a pyrethrin.

In respect of each aspect of the invention, the solution may include an insect attractant, for example a ketone based attractant.

### BRIEF DESCRIPTION OF THE DRAWINGS

The invention is described with reference to the following drawings in which:

FIGS. 1, 2 and 3 are photographs under microscope, of bed bug eggs, taken before and 24 hours after the application of a insecticidal composition in accordance with the invention ; and

FIG. 4 is a photograph of a petri dish in which is placed in filter paper soaked with an insecticidal composition in accordance with the invention and onto which is placed instar nymphs.

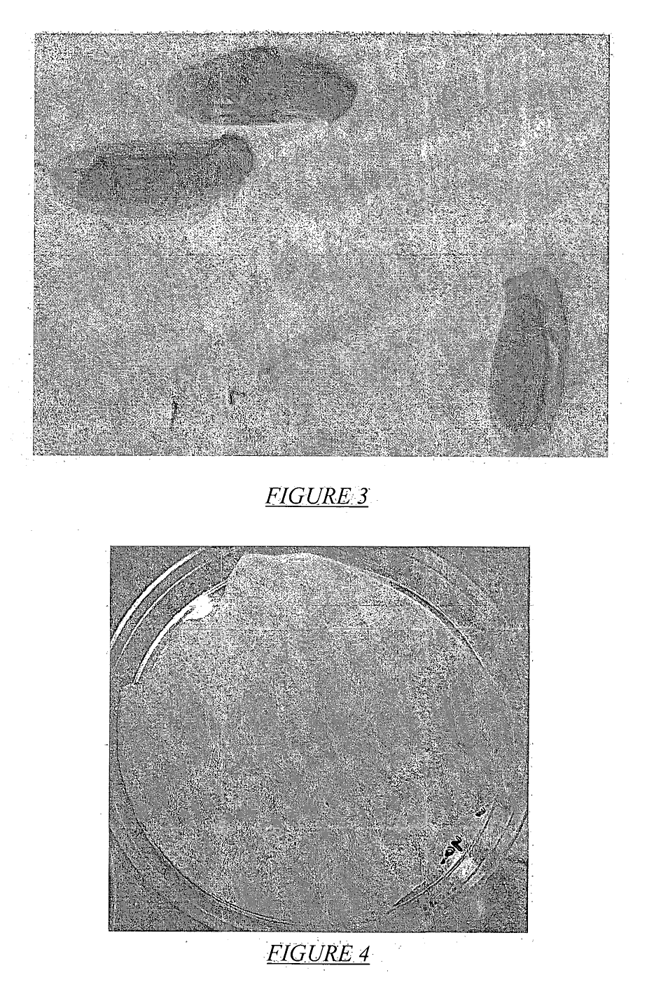

### DESCRIPTION OF PREFERRED EMBODIMENT

The biocidal efficacy of aldehydes resides in the aldehyde functional group. This functional group reacts with free amine groups of, for example, a cell membrane of an organism. Aldehydes have biocidal efficacy as they disrupt cellular process within target cells which ultimately kills the organism. However, prior to the invention, it was not known to use aldehydes, and in particular stabilized aldehydes, to control insects as the vectors of disease.

Without buffering and stabilizing, aldehydes (with the exception of formaldehyde and aldehydes with carbon chain lengths of 2 to 4 carbon atoms) have a tendency, especially at low concentrations, to adopt a cyclic molecular configuration, which results in the aldehyde molecule losing its biocidal efficacy and, at relatively higher concentrations over a period of time, aldehyde solutions tend to polymerize with other aldehyde molecules. Polymerization accelerates at temperatures greater than 50° C. (and at less than 4° C. for aldehydes that have chain lengths of less than 5 carbon atoms). Polymerization of aldehydes also results in a loss of biocidal effect. To overcome the problem of polymerization, it is known to dilute a product containing an aldehyde solution prior to use.

Raising the pH of an aldehyde solution activates the solution, which increases the reactivity of the aldehyde functional groups with amine groups and the associated biocidal effect upon cell membranes. The stability of the aldehyde solution, however, is compromised when the pH is raised. Higher pH aldehyde solutions are only stable for a matter of days.

With these inherent drawbacks in mind, the invention relates to the development of a novel array of biodegradable, insecticides and larvicides, and to methods of use of same, that are highly effective in their ability to kill eggs, larvae, nymphs, and pupae of many insect species, before developmental metamorphosis to an adult insect. The incidence and prevalence of diseases borne by insects can therefore be reduced due to the reduction of insect concentration and inherent transmission rates.

The insects that may be controlled in accordance with one or more aspects of the invention, include both flying and terrestrial insects, such as: ants, aphids, bed bugs, cicadas, cockroaches, fleas, flies, lice, mites, mosquitoes, moths, stink bugs, silverfishes and termites.

The diseases that can be indirectly controlled as a result of using relevant aspects of the invention as part of a IVC program include: Yellow Fever, Malaria, Dengue Fever, West Nile Virus, Eastern and Western Equine Encephalitis, Dog Heartworm and Myiasis.

However, to illustrate the full potential for the invention, a vector table is provided below which highlights a possible range of diseases that potentially can be controlled with the use of an insecticidal composition or a method of insect control in accordance with the invention.

TABLE 1

| VECTOR | DISEASE | PATHOGEN TYPE |
|---|---|---|
| Mosquitoes | Filariasis | Helminthes |
| | Malaria | Protozoa |
| | Derigue fever | Virus |
| | Yellow fever | Virus |
| | St Louis enceptialites | Virus |
| | Eastern equine enceptialites | Virus |
| | Wesern enquine encepphatis | Virus |
| | West nile | Virus |
| | River valley fever | Virus |
| Ticks | Lyme disease | Bacteria |
| | Rocky mountain spotted fever | Bacteria |
| | Q fever | Bacteria |
| | Tularemia | Bacteria |
| | Relapsing fever | Bacteria |
| | Ehilichiosis | Bacteria |
| | Colorado tick fever | Virus |
| | Crimean haemorrhagic fever | Virus |
| | Babesious | Protozoa |
| Mites | Q fever | Bacteria |
| | Rickeftsioses | Bacteria |
| Deer flies | Tularemia | Bacteria |
| Tsetse flies | Sleeping sickness (African | Protozoa |
| | Trpanosonias | |
| Blackflies | Orichoceriasis | Helminthes |
| Muscoid flies | Yaws | Bacteria |
| Sandflies | Leishmanasis | Protozoa |
| | Sanfly fever | Virus |
| | Vesicular stomatitis | Virus |
| Lice | Epidemic typhus | Bacteria |
| | Trench fever | Bacteria |
| Fleas | Endemic typhus | Bacteria |
| | Bubonicplague | Bacteria |
| Reduvids (also | Chagas disease | Protozoa |
| known as bed bugs, | (American | |
| kissing bugs, | terypanosomiasis) | |
| cone-nose bugs) | | |

The insecticidal composition of the invention is shown to be highly effective at controlling insects by disrupting one or more of the immature forms of the insect. The insecticidal composition controls insect infestation at these stages of development, without adversely impacting the environment; as the components of the compositions are readily biodegradable, non-caustic and non-corrosive.

It is thought that the insecticidal composition of the invention works in controlling insect infestation by:
a) the fixation and reduction of proteins and other nitrogen sources in or on the surface of insect eggs, larvae, nymphs and pupae (immature stages of an insect) that come in contact with the stabilized active carbonyl solution of the composition, and
b) in the case of insects laying their eggs on a water surface, the disruption of the surface tension of the water surface and the resultant destabilization and breaking apart of the floating “egg boat”.

With regards to this latter hypothesis, it is thought that the stable aqueous carbonyl solution, when produced by the method of preparation described below, disrupts the formation and integrity of the floating ‘egg boat’. Once the integrity is broken, then the cytoplasm of the eggs, and the emerging larvae and pupae, are fixed by the reducing carbonyl functional group. The pathogens hosted by these insects are also fixed. The result is death of the insect at its immature state and its hosted pathogen. The lifecycle is therefore interrupted, and there is a reduction in the concentration of viable vector insects, for example, mosquitoes. By reducing the concentration of viable insect vectors in an area, the incidence of new pathogenic infections is reduced as is the overall prevalence of the disease.

The stable aqueous carbonyl solution, according to the invention, is manufactured, in a concentrate solution preferably with the use of an aldehyde. The concentrate solution is, by definition, a solution in which the aldehyde concentration is in the range 2% to 20% m/v.

In participation a non-ionic surfactant, i.e. alcohol ethoxylate (of either 3, 5, 7 or 9 ethoxylate groups), is added to a predetermined volume of water. The mixture is heated to a temperature between 40° and 50° C. followed by an aldehyde or a mixture of aldehydes. Without limitation, single aldehydes from the following list were selected and stabilized using the methodology that follows to perform an array of tests that follow: glutaraldehyde, furfuraldehyde, nonanaldehyde, glyoxyl, succinaldehyde, or ortho-phthalaldehyde, iso-phthalaldehyde and adipaldehyde. Also, a carbonyl, being the terpenoid citral, was selected.

The selected aldehyde, lactone, ketone or terpenoid (hereinafter simply referred to as “aldehyde”) is allowed to complex with the chosen alcohol ethoxylate for a period of between 15 and 30 minutes whilst maintaining the temperature of the volume of water between 30° C. and 70° C. The result is an aldehyde-surfactant solution is produced. During this period of heating the aldehyde complexes with the alcohol ethoxylate substantially to completion.

Following this period, a further amount of water, at a temperature of less than 25° C., is added to the aldehyde-surfactant complex solution to reduce the temperature of the solution to below 30° C. thereby to slow and stop the complexing reaction of the alcohol ethoxylate with the aldehyde.

A pH modifier, such as potassium hydroxide, is then added in a sufficient quantity to adjust the pH of the aldehyde-surfactant complex solution to within 7.0 to 8.5. Potassium hydroxide is used in a one molar solution.

Finally a buffer mixture, preferably comprising sodium acetate, trihydrate and potassium acetate is added to the aldehyde-surfactant complex solution to produce a stable aqueous aldehyde solution in the concentrate solution. In Example 1 that follows, a buffer mixture of potassium acetate and sodium bicarbotrate is, however, used.

Sodium acetate trihydrate and potassium acetate each have a concentration in the buffer mixture of between 0.250 to 1.5 grams/liter. This concentrated solution is diluted when added to the aldehyde-surfactant complex solution to within a range 0.005% to 0.1% m/v.

It is thought that this method produces, in complexation, micelles of the aldehyde and surfactant in the aqueous solution.

As an insecticidal or larvacidal composition (hereinafter “insecticidal” and “larvacidal” are used interchangeably), the invention provides a method of preventing the hatching of insect eggs or killing of insect larvae, pupae or nymphs, by contact with a stable aqueous aldehyde solution of the composition.

The use of the insecticidal composition of the invention when added as a concentrate to a crop irrigation system, would address plant pathogens derived from, for example, spider mites, weevils, beetles and psyllids. In another application, the composition is useful in the treatment of laundry, mattresses and bedding to help eradicate nuisance insect infestations of bed bugs, fleas, mites and lice.

Further use of the insecticidal composition of the invention are in pre- and post-construction of homes and structures where subsequent possible invasions of ants, termites, bedbugs and other insects may be addressed and controlled at source i.e. at the nests of eggs. Application, in this use, can be in the form of a foam of the insecticidal composition.

The insecticidal composition also can be applied by ground spraying, aerial spraying, or by hand or mechanical dispersion, including but not limited to backpack or other hand held devices, hydraulic or air nozzles, granular applicators, electrostatic applicators, controlled droplet applicators (CDA), or ultra-low volume (ULV) applicators. Method of application will, of course, depend on the particular context. The composition is also suitable for application by low pressure spraying so that large areas including water or wetlands can be easily treated.

The composition can be applied in single or repeated applications until the target insect infestation is effectively inhibited. The conditions leading to effective insect inhibition depend, in part, on the environment. In some instances, a single application of the composition is sufficient, in another, a plurality of applications may be required. This is often dependent on climatic conditions.

In the examples that follow, various test protocols were followed in the application of the insecticidal composition in accordance with the invention to mosquitos and bedbugs. These two insect vectors were chosen due to the many diseases associated with, and topical issues surrounding, these particular insects. The choice is not intended to be limiting.

In the case of the bed bug tests, eggs were chosen as the immature stage of this particular insect, to set a high benchmark in insecticidal efficacy of the insecticidal composition as the eggs are known to be very difficult to kill due to their mineralized surface covering.

In the mosquito directed tests (Examples 1 and 2 in particular), the count of viable larvae and pupae in a liquid sample is used as a surrogate for the relative incidence of pathogenic disease in an area. In the case of Example 1, due to the choice of the mosquito species, the pathogenic disease is viral e.g. yellow fever. In the case of Example 2, again due to the choice of species, the disease is protozoal e.g. Malaria.

In these tests laboratory assays were carried out with a colony of insectary-reared larvae originally derived from wild-caught mosquitoes maintained at the South African Bureau of Standards (“SABS”). Larvae were fed by adding a pinch of crushed Tetramin® (Tetra, Germany) fish food spread evenly on the water surface twice daily.

Assays were performed to determine the minimum effective dosages of a 20% concentration stable aqueous aldehyde solution. Four groups of fifteen larvae each were selected for testing. The concentrate solution was diluted to five different test concentration, one dilution for each experiment. Each experiment was run in four concurrent replicates at the same time. Larvae were fed during the experiments and all tests were run at ambient temperature ranging between 21° C. and 34° C. After a 24 hour period larvae were counted and mortality scored.

A number of stable aqueous aldehyde solutions, differing in the aldehyde of choice, were studied for their relative efficacy by taking them through the same test or protocol described above. A representative of each of the following types of low molecular weight aldehydes (<12 carbons) was studied in this manner: a mono-aldehyde, a dialdehyde, a straight chain aldehyde, a branched chain aldehyde, a cyclic aldehyde, a halogen containing aldehyde and a water insoluble aldehyde.

Other components, notably a biodegradable twin chain quaternary ammonium compound and the surfactant, were also studied in isolation to understand their relative contribution to the insecticidal/larvicidal effect.

### Example 1

This test was conducted to determine the biological efficacy of a sample (marked “20% Aqua Cure”) against Aedes aegypti and Anopheles arabiensis mosquito larvae. Aqua Cure is a trade name for a composition of glutaraldehyde, a tergitol 15S9 surfactant, a polymer (polyvinyl pyrrolidone (“PVPK”)), a potassium acetate and sodium bicarbonate buffer and Arquad®. Aqua Cure is manufactured in accordance with the invention.

The test was performed in the SABS laboratories. The first exposures commenced on Aedes aegypti last instar larvae. Fifteen larvae were used per container (replicate). Four replicates were used for each of the three concentrations used. They were diluted, 1:10 and 1:100. Deionized water was used as diluent and where this was used the larvae were placed in the water before the sample was added. A separate set of four containers with larvae in deionized water only served as untreated controls. The larvae were supplied with laboratory diet as food. Mortality counts were made the next day.

A second set of exposures on Aedes larvae commenced the next day using dilutions of 1:500, 1:1000 and 1:2000 in the same manner as the first. Using the dilutions above, exposures were also carried out with 30 Anopheles arabiensis larvae per replicate.

The results are tabulated below:

TABLE 2

| | | MORTALITY COUNT | | | | |
|---|---|---|---|---|---|---|
| | | REPLICATES OUT OF 15 | | | | TOTAL OUT |
| MOSQUITO | DILUTION | 1 | 2 | 3 | 4 | OF 60 |
| Aedes | 0 | 15 | 15 | 15 | 15 | 60 |
| Aegypti | 1:10 | 15 | 15 | 15 | 15 | 60 |
| (Yellow | 1:100 | 15 | 15 | 15 | 15 | 60 |
| Fever) | 1:500 | 15 | 15 | 15 | 15 | 60 |
| | 1:1000 | 15 | 15 | 15 | 15 | 60 |
| | 1:2000 | 15 | 15 | 15 | 15 | 60 |

| | |
|---|---|
| OUT OF 30 | OUT OF 120 |

| | | | | | | |
|---|---|---|---|---|---|---|
| Anopholos | 1:500 | 30 | 30 | 30 | 30 | 120 |
| Aerobionsis | 1:1000 | 30 | 30 | 30 | 30 | 120 |
| (Malaria) | 1:2000 | 30 | 30 | 30 | 30 | 120 |

NOTE:
All the untreated control larvae were alive after the exposure period.

### Example 2

This test was conducted to determine the biocidal efficacy of each of the samples listed below against Aedes aegypti larvae.

Samples Tested:
1. Original Product #1012 30/11/08 aged 6 month coded “1” (glutaraldehyde +PVPK+sodium acetate trihydrate +sodium bicarbonate);
2. 2-furfuraldehyde 10% complexed 16/3/9 coded “2” (furfuraldehyde+Tergitol 15S9+sodium acetate trihydrate+sodium bicarbonate);
3. N-Nonanal complexed 16/3/9 coded “3” (nonanaldehyde+Tergitol™ 15S9 +sodium acetate trihydrate+sodium bicarbonate);
4. Glyoxyl complex 16/3/9 coded “4” (glyoxyl+Tergitol™ 15S9+sodium acetate trihydrate+sodium bicarbonate);
5. Arquad® Q.A.L 4001094749 coded “5” (twin chain quaternary ammonium compound);
6. GK 10 BB 1060 coded “6” (glutaraldehyde+Tergitol™ 15S9+potassium acetate+sodium bicarbonate);
7. 20% Aqua Cure (glutaraldehyde+PVPK+Arquad®+Tergitol™ 15S9+potassium acetate+sodium bicarbonate).

Each of the samples subjected to this test were manufactured in accordance with the methodology described above.

The test was performed in the SABS laboratories. The exposure commenced on last instar larvae. Fifteen larvae were placed in each of 60 plastic containers (each a “replicate”) filled with 500 mg deionized water. The contents of the sample containers were shaken prior to adding the correct volume to the containers with deionized water and larvae to obtain dilutions of 1:2000 and 1:4000 respectively. Four replicates were used for each treatment. The remaining four containers with larvae served as untreated controls. The larvae were supplied with laboratory diet as food. Morality counts were made after 48 hours.

TABLE 3

| | | MORTALITY COUNT | | | | |
|---|---|---|---|---|---|---|
| SAMPLE | | REPLICATES OUT OF 15 | | | | TOTAL OUT |
| OR CODE | DILUTION | 1 | 2 | 3 | 4 | OF 60 |
| 1 | 1:2000 | 15 | 15 | 15 | 15 | 60 |
| | 1:4000 | 15 | 15 | 15 | 13 | 58 |
| 2 | 1:2000 | 12 | 9 | 7 | 6 | 34 |
| | 1:4000 | 0 | 1 | 0 | 0 | 1 |
| 3 | 1:2000 | 14 | 10 | 12 | 15 | 51 |
| | 1:4000 | 2 | 1 | 2 | 0 | 5 |
| 4 | 1:2000 | 0 | 0 | 0 | 0 | 0 |
| | 1:4000 | 0 | 0 | 0 | 0 | 0 |
| 5 | 1:2000 | 15 | 15 | 15 | 15 | 60 |
| | 1:4000 | 15 | 15 | 15 | 15 | 60 |
| 6 | 1:2000 | 0 | 0 | 0 | 0 | 0 |
| | 1:4000 | 0 | 0 | 0 | 0 | 0 |
| 7 | 1:2000 | 15 | 15 | 15 | 15 | 60 |
| | 1:4000 | 15 | 15 | 15 | 15 | 60 |

### Example 3

All the untreated control larvae were alive after the exposure period.

This test was conducted to determine the biological efficacy of the samples listed below against mosquito larvae, pupae and eggs.

Samples tested:
1. a 200 ml plastic bottle with approximately 30 ml liquid coded “7”;
2. a 200 ml plastic bottle with approximately 60 ml liquid coded “8”; and
3. 20% Aqua Cure™.

This test was performed at the SABS laboratories and started with exposure on Aedes aegypti larvae (+/−10 mm) commenced 30 Mar. 2009. Ten larvae were placed in each of 28 plastics containers (“replicate”) filled with 500 ml deionized water. The contents of the sample containers were shaken prior to adding the correct volume to the containers with deionized water and larvae to obtain dilutions of 1:2000 and 1:4000 respectively. Four replicates were used for each treatment. The remaining four containers with larvae served as untreated controls. The larvae were supplied with laboratory diet as food. Morality counts were made after 48 hours.

A second part of the test involved Anopheles arabiensis pupae were 5 pupae were placed in each of the first two replicates of each treatment. The number of adults that hatched were counted after 48 hours.

A third part of the test involved a rafter of Anopheles arabiensis eggs being placed in replicates, three per treatment. Food was supplied in each container with the eggs. Three days later, each container was examined for live larvae.

The results are tabulated below:

TABLE 4

| | | MORALITY COUNTS OF | | | | |
|---|---|---|---|---|---|---|
| | | AEDES AEGYPTI LARVAE | | | | |
| SAMPLE | | REPLICATES OUT OF 10 | | | | TOTAL OUT |
| OR CODE | DILUTION | 1 | 2 | 3 | 4 | OF 40 |
| 7 | 1:2000 | 10 | 10 | 10 | 10 | 40 |
| | 1:4000 | 10 | 10 | 10 | 10 | 40 |
| 8 | 1:2000 | 10 | 10 | 10 | 10 | 40 |
| | 1:4000 | 10 | 10 | 10 | 10 | 40 |
| AQUA | 1:2000 | 10 | 10 | 10 | 10 | 40 |
| CURE | 1:4000 | 10 | 10 | 10 | 10 | 40 |

TABLE 5

| | | NUMBER OF ANOPHELAS | | |
|---|---|---|---|---|
| | | ARABIENSIS ADULTS THAT | | |
| | | EMERGED FROM PUPAE | | |
| | | REPLICATES | | |
| SAMPLE | | OUT OF 5 | | TOTAL OUT |
| OR CODE | DILUTION | 1 | 2 | OF 10 |
| 7 | 1:2000 | 5 | 5 | 10 |
| | 1:4000 | 0 | 0 | 0 |
| 8 | 1:2000 | 0 | 0 | 0 |
| | 1:4000 | 0 | 0 | 0 |
| AQUA | 1:2000 | 0 | 0 | 0 |
| CURE | 1:4000 | 0 | 0 | 0 |

TABLE 6

| | | NUMBER OF LIVE ANOPHELES | | |
|---|---|---|---|---|
| | | ARABLENSIS LARVAE | | |
| | | REPLICATES | | |
| SAMPLE | | OUT OF 10 | | TOTAL OUT |
| OR CODE | DILUTION | 3 | 4 | OF 40 |
| 7 | 1:2000 | 0 | 0 | 0 |
| | 1:4000 | 0 | 0 | 0 |
| 8 | 1:2000 | 0 | 0 | 0 |
| | 1:4000 | 0 | 0 | 0 |
| AQUA | 1:2000 | 0 | 0 | 0 |
| CURE3 | 1:4000 | 0 | 0 | 0 |

### Example 4

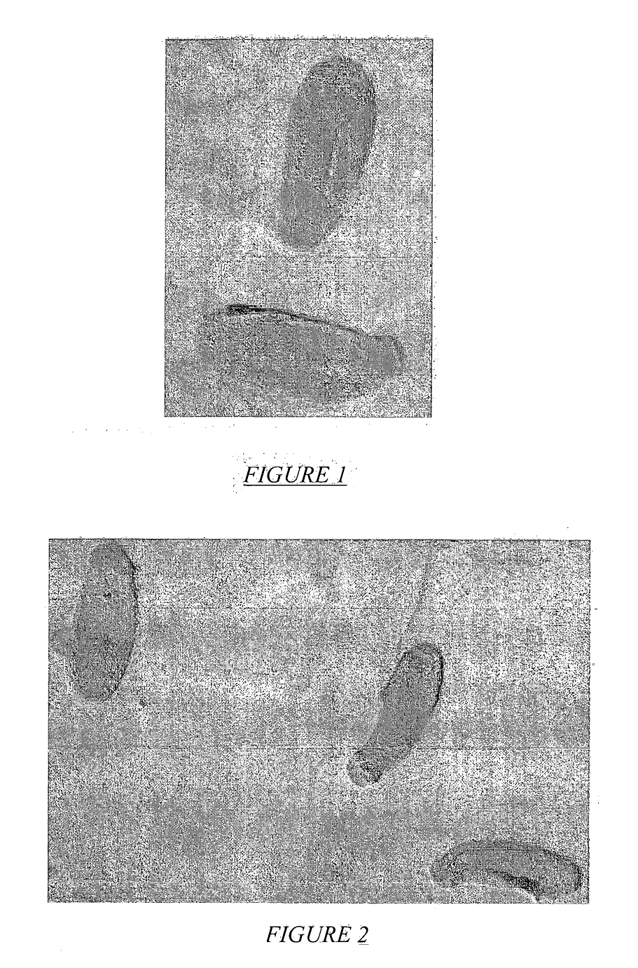

Bed bug eggs were collected five days after the bed bugs had been fed. The eggs that were used were white and smooth in appearance as seen in FIG. 1. 10 bed bug eggs were placed into a petri dish containing 1 ml of either a control or a Microbidex-G solution. All eggs were immersed under the solution for 24 hours. After a 24 hour incubation period at 25° C. (60% relative humidity) the bed bug eggs were placed onto dry filter paper and left to incubate for a further 14 days.

Microbidex-G is a tradename for a composition, manufactured in accordance with the invention, which includes glutaraldehyde, tergitol 15S9 and a buffer of sodium acetate tri-hydrate and potassium acetate.

FIG. 2 shows the bed bug eggs following 24 hours of incubation with the control while FIG. 3 shows the bed bug eggs after 24 hours of incubation with concentrated (10%) Microbidex-G.

As can be seen in FIG. 3, the bed bug eggs incubated with Microbidex-G changed to a brown colour when compared to the eggs incubated with the control. This indicates that the eggs are non-viable.

### Example 5

Ten first instar nymphs bedbugs were placed onto filter paper soaked with 1 ml of either a control or 10% Microbidex-G, a 1/100 and dilution or a 1/1000 dilution, for 24 hours at 25° C. (60% relative humidity). After 24 hours the first instar nymphs were checked for viability by prodding with a set of forceps.

The above graph details the number of dead and alive first instar nymphs following 24 hours of incubation with either the control or Microbidex-G solution. Incubation with Microbidex-G has increased the morality if first instar nymphs when compared to the control.

### Example 6

This test involved the count of the number of surviving bed bugs 24 hours after a 1 minute exposure to a number of test solutions of 30% Microbidex-G at different dilutions.

The samples studied were on instar nymphs. The nymphs had a human blood feed the week before.

| Sample description | PPM | Survival % |
|---|---|---|
| Deionized water | — | 90% |
| Microbidex-G (3.0% stabilized activated glutaraldehyde) = neat | 30,000 | 3% |
| Microbidex-G (3.0% stabilized activated glutaraldehyde) = 1:100 dilution | 300 | 53% |
| Microbidex-G (3.0% stabilized activated glutaraldehyde) = 1:1000 dilution | 30 | 77% |
| Tide HE ® (1 cap in 75 liters = working solution) | | 80% |
| Tide HE ® + Microbidex-G (1:1) | | 7% |

What is notable is the high mortality rate, in the concentrate and Tide HE® samples and this rate is achieved only after a minute of exposure.

### Example 7

In this test, 120 mated, female (lab strained) bed bugs were ordered. The transit time for shipment was between 7-10 days during which time the female bed bugs laid eggs on a piece of white, corrugated paper. The paper that contained all the bed bugs, nymphs, and eggs were removed and placed on a disposable petri dish (60 mm×15 mm). All nymphs and adult bed bugs were removed using flexible forceps and placed back into a vial. Using forceps, bed bug eggs were carefully scraped from the paper and collected in the petri dish.

Five Microbidex formulations were used in this study (Microbidex “C”, Microbidex, “G”, Microbidex “I”, Mlcrobidex “N”, Microbidex “S”). Each formulation is a composition, manufactured in accordance with the invention, containing citral, glutaraldehyde, iso-phthalaldehyde, nonanoldehyde and succindaldehyde respectively.

Microbidex “C”, “G”,“N”, and “S” were tested at 100%, 50%, and 10% of the sample concentrations provided. Formulations were diluted using acetone and an acetone only solution was used as a control. Mlcrobidex “I” did not stay in solution, so it was diluted to 10%, 5%, and 1% of the sample concentration provided.

Whatman #1 5.5 cm filter paper (Cat No Whatman, 1001-055) were placed inside a petri dish and 25 μL of each concentration was dispensed onto the filter paper using a pipette to ensure complete saturation of the filter paper. Each sample and the acetone control were replicated three times. Bed bug eggs were checked under the microscope to determine their viability. Viable eggs can be identified by their pearly grey color and the eggs should appear round and smooth with the red eyes of the developing nymph visible. Eggs that were collapsed or dented were non-viable and hatched eggs were white and transparent. Three to five, viable eggs were collected and placed in the center of each filter paper and lids placed back over the Petri dish. The number of initial eggs for each sample was recorded.

Each sample was examined under the microscope daily for 6 days to determine egg mortality. Eggs were recorded either as viable, dead, or hatched (nymphs). At the end of the experiment, samples and supplies were placed in the freezer at −40° C. to kill off all surviving eggs and nymphs. Tables, tray, and equipment were sprayed with Ortho® Home Defense Dual-Action Bed Bug Killer after each day of testing.

The results are tabulated below:

TABLE 8

| Treatment | active ingredient | Day 1 | Day 2 | Day 3 | Day 4 | Day 5 | Day 6 |
|---|---|---|---|---|---|---|---|
| Control | | 0 | 7.69 | 7.69 | 7.69 | 7.69 | 15.38 |
| (Acetone Only) | | | | | | | |
| Microbidex “C” | 10% citral | 0 | 28.57 | 28.57 | 50.00 | 50.00 | 50.00 |
| | 5% citral | 0 | 18.18 | 18.18 | 36.36 | 36.36 | 36.36 |
| | 1% citral | 0 | 9.09 | 9.09 | 9.09 | 9.09 | 9.09 |
| Microbidex “G” | | | | | | | |
| | 3.0% glutaraldehyde | 0 | 9.09 | 9.09 | 18.18 | 18.18 | 18.18 |
| | 1.5% glutaraldehyde | 0 | 7.69 | 7.69 | 7.69 | 15.38 | 15.38 |
| | 1.0% glutaraldehyde | | | | | | |
| | 0.3% glutaraldehyde | 0 | 0.00 | 0.00 | 8.33 | 8.33 | 8.33 |
| Microbidex “I” (10%) | | | | | | | |
| | 1.0% isophthalaldehyde | 0 | 9.09 | 9.09 | 9.09 | 36.36 | 36.36 |
| | 0.5% isophthalaldehyde | 0 | 25.00 | 25.00 | 33.33 | 33.33 | 41.67 |
| | 0.1% isophthalaldehyde | 0 | 20.00 | 20.00 | 30.00 | 30.00 | 30.00 |
| Microbidex “N” | 10.0% nonanal | 0 | 7.69 | 7.69 | 15.38 | 46.15 | 69.23 |
| | 5.0% nonanal | 0 | 9.09 | 9.09 | 9.09 | 9.09 | 9.09 |
| | 1.0% nonanal | 0 | 16.67 | 16.67 | 16.67 | 25.00 | 25.00 |
| Microbidex “O” | | | | | | | |
| Microbidex “S” | 10.0% succindialdehyde | 0 | 0.00 | 0.00 | 0.00 | 0.00 | 0.00 |
| Microbidex “S” | 5.0% succindialdehyde | 0 | 0.00 | 0.00 | 13.33 | 13.33 | 13.33 |
| Microbidex “S” | 1.0% succindialdehyde | 0 | 0.00 | 0.00 | 0.00 | 0.00 | 0.00 |

Notably in this test is the adaptation of a high hurdle of insecticidal efficacy in that eggs were chosen as the immature stage and the relevant insecticidal composition was applied to the filter paper before the introduction of the eggs to the paper. The composition was not applied directly to the eggs by soaking or dipping.

This test mimicked a real life application in which the composition would be applied to, for example, bedding onto which the bed bugs would thereafter infect.

1. A method of insect control by reducing the surface tension of a body of water containing the egg stage of the insect, the method including the step of applying a stable aqueous carbonyl compound containing solution to the surface of the body of water, wherein the solution includes:
a) at least one carbonyl compound;
b) a surfactant or detergent;
c) a pH modifier; and
d) a buffer.

2. A method according to claim 1 wherein the solution is prepared, prior to application, by:
(a) adding the surfactant to a volume of water, heated to between 30° C. and 70° C.;
(b) adding the pH modifier to adjust the pH of the solution to within 6.0 to 8.5
(c) adding at least one carbonyl compound to the body of water, to allow the carbonyl compound and the surfactant to complex, whilst maintaining the temperature within the range 30° C. and 70° C., for at least 10 minutes;
(d) reducing the temperature of the body of water to below 30° C. to slow further complexation of the carbonyl compound with the surfactant; and
(e) adding the buffer to the solution to buffer the pH and to produce the stable aqueous carbonyl compound containing solution.

3. A method according to claim 1 wherein the carbonyl compound is at least one of the following: an aldehyde, a ketone, a terpenoid and a lactone.

4. A method according to claim 3 wherein the terpenoid is citral and the ketone is acetone.

5. A method according to claim 1 wherein the following are present in the solution in the following concentration ranges:
a) the carbonyl compound—0.001% to 45% m/v;
b) the surfactant or detergent—0.1% to 45% m/v; and
c) the buffer—0.05% to 25% m/v.

6. A method according to claim 1 wherein the surfactant or detergent is one or more of the following: an alcohol ethoxylate surfactant, a nonylphenol surfactant, an alkyl glycoside, sulphonic acid, sodium lauryl ethyl sulphate, sodium lauryl sulphate, a twin chain quaternary ammonium compound, cocopropyldiamide (CPAD), alkyl sulphate esters, benzenesulfonic acid, C10-13-alkyl derivatives and their sodium salts, D-glucopyranose, oligomeric glycosides and sorbitan monostearate.

7. A method according to claim 1 wherein the buffer includes at least one of the following: calcium acetate, magnesium acetate, sodium acetate, sodium acetate tri-hydrate, potassium acetate, lithium acetate, propylene glycol, hexalene glycol, sodium phosphate, sodium tri-phosphate, potassium phosphate, lithium phosphate, zinc perchlorate, zinc sulphate, cupric chlorate and cupric sulphate.

8. A method according to claim 1 wherein when the at least one carbonyl compound is an aldehyde, the aldehydes is at least one of the following: formaldehyde, acetaldehyde, glyceraldehyde, proprionaldehyde, butraldehyde, pentanaldehyde, methyl pentanaldehyde, ethyl pentanaldehyde, tiglic aldehyde, valeraldehyde, iso-valeraldehyde, hexanaldehyde, heptanaldehyde, octanaldehyde, nonanaldehyde, 2-ethyl hexaldehyde, decanaldehyde, undecanaldehyde, dodecyl aldehyde, cuminaldehyde, benzaldehydes, iso-valeraldehyde, chloraldehyde hydrate, furfuraldehyde, paraformaldehyde, ethane dialdehyde, glyoxal, succinaldehyde, glutaraldehyde, adipaldehyde, iso-phthalaldehyde, ortho-phthalaldehyde, cinnamaldehyde, salicylaldehyde and malonaldehyde.

9. A method of insect control comprising the step of applying, to an environment containing an immature form of the insect, a stable aqueous carbonyl compound containing solution, the solution including:
a) at least one carbonyl compound.
b) a surfactant or detergent;
c) a pH modifier; and
d) a buffer.

10. A method according to claim 9 wherein the carbonyl compound is at least one of the following: an aldehyde, a ketone, a terpenoid and a lactone.

11. A method according to claim 9 wherein the solution is applied to the environment by spraying a dispersant.

12. A method according to claim 11 wherein the dispersant is a diluted form of the stable aqueous carbonyl solution, diluted either with distilled or potable water, an alcohol or a solvent.

13. A method according to claim 11 wherein the solution or the dispersant is applied in the form of a spray, a fog, a foam or mist.

14. A method according to claim 9 wherein the solution is applied as an additive to a granule or pellet of a compressed binding substance.

15. A method according to claim 9 wherein the following are present in the solution in the following concentration ranges:
a) the carbonyl compound—0.001% to 45% m/v;
b) the surfactant or detergent—0.1% to 45% m/v; and
c) the buffer—0.05% to 25% m/v.

16. A method according to claim 9 wherein the surfactant or detergent is one or more of the following: an alcohol ethoxylate surfactant, a nonylphenol surfactant, an alkyl glycoside, sulphonic acid, sodium lauryl ethyl sulphate, sodium lauryl sulphate, a twin chain quaternary ammonium compound, cocopropyldiamide (CPAD), alkyl sulphate esters, benzenesulfonic acid, C10-13-alkyl derivatives and their sodium salts, D-glucopyranose, oligomeric glycosides and sorbitan monostearate.

17. A method according to claim 9 wherein the buffer includes at least one of the following: calcium acetate, magnesium acetate, sodium acetate, sodium acetate tri-hydrate, potassium acetate, lithium acetate, propylene glycol, hexalene glycol, sodium phosphate, sodium tri-phosphate, potassium phosphate, lithium phosphate, zinc perchlorate, zinc sulphate, cupric chlorate and cupric sulphate.

18. A method according to claim 9 wherein, when the at least one carbonyl compound is an aldehyde, the aldehyde is at least one or more of the following: formaldehyde, acetaldehyde, glyceraldehyde, proprionaldehyde, butraldehyde, pentanaldehyde, methyl pentanaldehyde, ethyl pentanaldehyde, tiglic aldehyde, valeraldehyde, iso-valeraldehyde, hexanaldehyde, heptanaldehyde, octanaldehyde, nonanaldehyde, 2-ethyl hexaldehyde, decanaldehyde, undecanaldehyde, dodecyl aldehyde, cuminaldehyde, benzaldehydes, iso-valeraldehyde, chloraldehyde hydrate, furfuraldehyde, paraformaldehyde, ethane dialdehyde, glyoxal, succinaldehyde, glutaraldehyde, adipaldehyde, iso-phthalaldehyde, ortho-phthalaldehyde, cinnamaldehyde, salicylaldehyde and malonaldehyde.

19. An insecticidal composition which includes:
a) at least one carbonyl compound;
b) a surfactant or detergent;
c) a pH modifier; and
d) a buffer.

20. An insecticidal composition according to claim 19 wherein the carbonyl compound is at least one of the following: an aldehyde, a ketone, a terpenoid and a lactone.

21. An insecticidal composition according to claim 20 wherein the terpenoid is citral and the ketone is acetone.

22. An insecticidal composition according to claim 19 wherein the following are present in the solution in the following concentration ranges:
a) the carbonyl compound—0.001% to 45% m/v;
b) the surfactant or detergent—0.1% to 45% m/v; and
c) the buffer—0.05% to 25% m/v.

23. An insecticidal composition according to claim 19 wherein the surfactant or detergent is one or more of the following: an alcohol ethoxylate surfactant, a nonylphenol surfactant, an alkyl glycoside, sulphonic acid, sodium lauryl ethyl sulphate, sodium lauryl sulphate, a twin chain quaternary ammonium compound, cocopropyldiamide (CPAD), alkyl sulphate esters, benzenesulfonic acid, C10-13-alkyl derivatives and their sodium salts, D-glucopyranose, oligomeric glycosides and sorbitan monostearate.

24. An insecticidal composition according to claim 19 wherein the buffer includes at least one of the following: calcium acetate, magnesium acetate, sodium acetate, sodium acetate tri-hydrate, potassium acetate, lithium acetate, propylene glycol, hexalene glycol, sodium phosphate, sodium tri-phosphate, potassium phosphate, lithium phosphate, zinc perchlorate, zinc sulphate, cupric chlorate and cupric sulphate.

25. An insecticidal composition according to claim 19 wherein, when the at least one carbonyl compound is an aldehyde, the aldehyde is one or more of the following: formaldehyde, acetaldehyde, glyceraldehyde, proprionaldehyde, butraldehyde, pentanaldehyde, methyl pentanaldehyde, ethyl pentanaldehyde, tiglic aldehyde, valeraldehyde, iso-valeraldehyde, hexanaldehyde, heptanaldehyde, octanaldehyde, nonanaldehyde, 2-ethyl hexaldehyde, decanaldehyde, undecanaldehyde, dodecyl aldehyde, cuminaldehyde, benzaldehydes, iso-valeraldehyde, chloraldehyde hydrate, furfuraldehyde, paraformaldehyde, ethane dialdehyde, glyoxal, succinaldehyde, glutaraldehyde, adipaldehyde, iso-phthalaldehyde, ortho-phthalaldehyde, cinnamaldehyde, salicylaldehyde and malonaldehyde.

26-32. (canceled)
